(19) United States
(12) Patent Application Publication
(10) Pub. No.: US 2011/0290409 A1
(43) Pub. Date: Dec. 1, 2011

(54) Method and System for Forming an Extruded Jacket Over Elongated Objects

(75) Inventor: Pierre-Richard Jacques, Cape Coral, FL (US)

(73) Assignee: Dekoron Unitherm LLC, Cape Coral, FL (US)

(21) Appl. No.: 13/116,634

(22) Filed: May 26, 2011

Related U.S. Application Data
(60) Provisional application No. 61/349,436, filed on May 28, 2010.

(51) Int. Cl. B65H 81/06; B65C 9/04

(52) U.S. Cl. 156/185; 156/446

(57) ABSTRACT

A system and method for forming an extruded jacket over an elongated object is provided. The system includes a quantity of heated jacketing material and at least one die having an entry side and an exit side, the entry side proximate to the quantity of heated jacketing material, wherein the quantity of heated jacketing material is extruded through the at least one die. A heating device is located proximate to the exit side of the at least one die, wherein the heating device positioned to maintain the extruded quantity of heated jacketing material in a heated state. A wrapping device is positioned to rotate the elongated object, wherein the extruded quantity of heated jacketing material is wrapped around at least a portion of the elongated object.

### CROSS REFERENCE TO RELATED APPLICATION

This application claims benefit of U.S. Provisional Application Ser. No. 61/349,436, entitled, “Method and System for Forming an Extruded Jacket over Elongated Objects,” filed, May 28, 2010, the entire disclosure of which is incorporated herein by reference.

### FIELD OF THE DISCLOSURE

The present disclosure is generally related to a jacketing apparatus and more particularly is related to a method and system for forming an extruded jacket over elongated objects.

### BACKGROUND OF THE DISCLOSURE

The process of extruding a jacket using a crosshead die has been in practice for many years. It has proved successful in many applications where a jacket is needed to cover an object. Commonly, a jacketing material is heated and extruded through a crosshead die where it takes the shape of the crosshead die. When the jacketing material exits the crosshead die, it hardens and must be applied to an object within a short period of time, thus constraining a jacketing process to a relatively quick time table. Additionally, conventional jacketing process requires various sized parts, such as die heads, for different sizes of the object to be jacketed. This can add significant cost and time to a jacketing process, as various components of a jacketing machine must be changed frequently.

Thus, a heretofore unaddressed need exists in the industry to address the aforementioned deficiencies and inadequacies.

### SUMMARY OF THE DISCLOSURE

Embodiments of the present disclosure provide a system and method for forming an extruded jacket over an elongated object. Briefly described, in architecture, one embodiment of the system, among others, can be implemented as follows. A quantity of heated jacketing material is provided. At least one die has an entry side and an exit side, the entry side proximate to the quantity of heated jacketing material, wherein the quantity of heated jacketing material is extruded through the at least one die. A heating device is located proximate to the exit side of the at least one die, wherein the heating device positioned to maintain the extruded quantity of heated jacketing material in a heated state. A wrapping device is positioned to rotate the elongated object, wherein the extruded quantity of heated jacketing material is wrapped around at least a portion of the elongated object.

The present disclosure can also be viewed as providing methods for forming an extruded jacket over an elongated object. In this regard, one embodiment of such a method, among others, can be broadly summarized by the following steps: heating a quantity of jacketing material; extruding the heated quantity of jacketing material through at least one die; maintaining the extruded, heated quantity of jacketing material in a heated state; and wrapping the extruded, heated quantity of jacketing material around at least a portion of an outer surface of the elongated object, wherein the extruded, heated quantity of jacketing material substantially surrounds an exterior surface of the elongated object.

Another embodiment of a method for forming an extruded jacket over an elongated object, among others, can be broadly summarized by the following steps: extruding a substantially uniform sheet of heated jacketing material through a sheet die; maintaining the extruded jacketing material in a heated state within an oven, wherein the oven is positioned to substantially surround an exit point of the sheet die and a section of the elongated object positioned proximate to the exit point of the sheet die; helically wrapping the extruded jacketing material about the elongated object; and cooling the wrapped elongated object.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a partial cross-sectional illustration of a system for forming an extruded jacket over an elongated object, in accordance with a first exemplary embodiment of the present disclosure.

FIG. 2 is a side-view, cross-sectional illustration of a system for forming an extruded jacket over an elongated object, in accordance with the first exemplary embodiment of the present disclosure.

FIG. 3 is a partial cross-sectional illustration of a system for forming an extruded jacket over an elongated object, in accordance with the first exemplary embodiment of the present disclosure.

FIGS. 4A-4C are cross-sectional illustrations of a system for forming an extruded jacket over an elongated object, in accordance with the first exemplary embodiment of the present disclosure.

FIGS. 5A-5C are cross-sectional illustrations of a system for forming an extruded jacket over an elongated object, in accordance with the first exemplary embodiment of the present disclosure.

FIG. 6 is a cross-sectional illustration of a system for forming an extruded jacket over an elongated object, in accordance with a second exemplary embodiment of the present disclosure.

FIG. 7 is a flowchart illustrating a method for forming an extruded jacket over an elongated object, accordance with the first exemplary embodiment of the disclosure.

FIG. 8 is a flowchart illustrating a method for forming an extruded jacket over an elongated object, accordance with a third exemplary embodiment of the disclosure.

### DETAILED DESCRIPTION

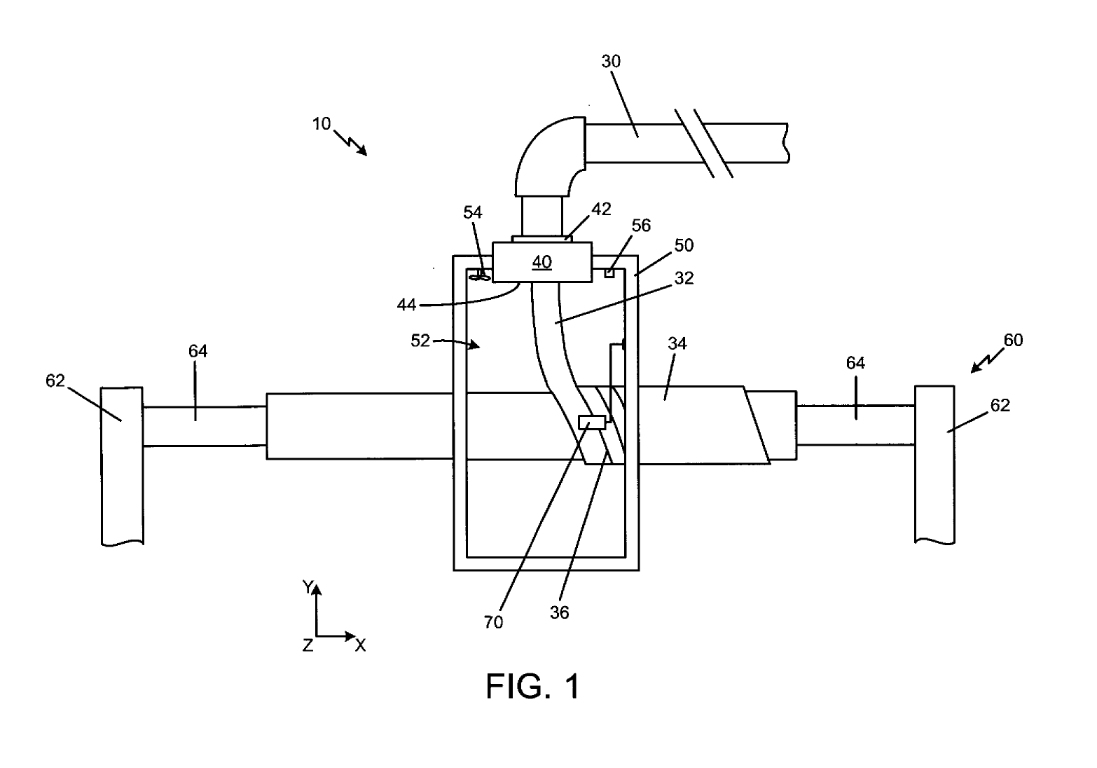

FIG. 1 is a partial cross-sectional illustration of a system 10 for forming an extruded jacket over an elongated object 20, in accordance with a first exemplary embodiment of the present disclosure. The system 10 for forming an extruded jacket over an elongated object 20, which may be simply referred to as ‘system 10’, includes a quantity of heated jacketing material 30. At least one die 40 has an entry side 42 and an exit side 44, wherein the entry side 42 proximate to the quantity of heated jacketing material 30. The quantity of heated jacketing material 30 is extruded through the at least one die 40. A heating device 50 is located proximate to the exit side 44 of the at least one die 40. The heating device 50 is positioned to maintain the extruded quantity of heated jacketing material 32 in a heated state. A wrapping device 60 is positioned to rotate the elongated object 20. When rotating, the extruded quantity of heated jacketing material 32 is wrapped around at least a portion of the elongated object 20.

The system 10 may be employed in a variety of industries that require jacketed objects, such as jacketed pipes or jacketed cables. Presently, jacketing an object using an extruded jacketing material may be completed with a crosshead die. Although this technique has proved successful for many years, it has inherent shortcomings. These include inherent structural limitations, including the need for interchanging various equipment and tooling parts. For example, as the size of the objects that require jacketing increases, a greater variety of equipment and tooling devices are needed, since specifically sized equipment and tooling devices are required for specifically sized objects. The present disclosure may allow for objects of various sizes to be jacketed without the need for replacement of equipment and tooling device.

The system 10 includes an elongated object 20 that is in a position to be jacketed by the system 10. The elongated object 20 may include object that requires jacketing, or benefit from jacketing. An object with a jacket coating may be protected from, or less susceptible to damage, wear and tear, or harmful environments. For example, in many industrial settings, various pipes, conduits, and cables are needed to transport products or energy from one location to another. Some of these pipes, conduits, or cables may be open to the elements such that they are subject to inclement weather, or being contacted from tools, machinery, or other items. If the pipe, conduit, or cable is damaged, it may be expensive and time consuming to make necessary repairs, which may require significant down time of the facility where the pipe, conduit, or cable is used. The system 10 may allow for these pipes, conduits, and cables, as well as other elongated objects, to be jacketed and protected from damage.

As is shown in FIG. 1, a quantity of heated jacketing material 30 that is provided to the die 40 with a series of pipes and pipe fittings. However, the jacketing material 30 may be provided to the die 40 with any other system or method. For example, the heated jacketing material 30 may be housed proximate to the die 40 and provided to the die 40 manually, automatically, with a hopper, or any other structure. The quantity of heated jacketing material 30 may include a variety of materials that can be used to jacket objects. The base materials of the jacketing material 30 may include solid pellets of jacketing material that are heated to form a malleable material having a substantially molten consistency capable of being extruded. The heated jacketing material 30 may include a variety of materials, including polymeric materials, polyvinyl materials, urethanes, 2-part polyethylene materials, other forms of vinyl, or any combination thereof. The jacketing material 30 may be a polymer-based material, which may include natural or synthetic materials, such as, for example, synthetic polymeric materials such as synthetic rubber, Bakaelite, neoprene, polyvinyl chloride (PVC), polystyrene, polyethylene, polyacrylonitrile, silicon, and many others. Other types of heated jacketing materials 30 may also be used, as one having ordinary skill in the art would recognize.

The quantity of heated jacketing material 30 may be heated to a temperature that is dependent on the type of jacketing material used. The heated jacketing material 30 will be at a temperature that results in the heated jacketing material being a substantially molten consistency, soft enough to be malleable, but hard enough to take a given shape. This may include a substantially molten consistency that allows the quantity of heated jacketing material 30 to be extruded into a substantially flat sheet. The jacketing material 30 may be provided to the die 40 in a variety of ways, such as with a system of pipes, as is shown in FIG. 1.

The jacketing material 30 may be heated prior to it being molded through the die 40, which may occur at any point prior to it being molded through the die 40. For example, the jacketing material 30 may be first heated, and then pumped to the die 40. Other configurations are also possible. For example, the die 40 may include a heating section that pre-heats the jacketing material 30 prior to entering the die 40. The jacketing material 30 may be heated to a consistency where it is capable of being submitted to the die 40, it can successfully pass through the die 40, and where it can retain the shape of the die 40 after it exits the die 40. For example, the jacketing material 30 may have a molten consistency when it is heated before entry to the die 40. When it is passed through the die 40, the jacketing material 40 may be cooled slightly to the point where the jacketing material 30 holds the shape of the die 40.

Naturally, different types of jacketing materials 30 may require different heating temperatures, all of which are considered within the scope of the present disclosure. Furthermore, as will be discussed herein, the rate of jacketing (i.e., the rate of movement between the components of the system 10 and the elongated object 20) may also dictate the temperature of the jacketing material 30. The jacketing material 30 may be heated to the point where it is malleable, or substantially molten. At this consistency, the jacketing material 30 may be malleable enough to be processed through the die 40, yet resistant enough to hold the shape that the die 40 gives it.

The die 40 has an entry side 42 and an exit side 44, which may generally oppose each other, but may also be in a configuration where the entry side 42 and the exit side 44 are not in direct, or substantial opposition. In accordance with this disclosure, the entry side 42 of the die 40 is the side or sides of the die 40 that receives the heated jacketing material 30, whereas the exit side 44 of the die 40 is the side or sides of the die 40 that emits the extruded jacketing material 30 into the heating device 50. The operation of an extrusion process with a die 40 is well known in the art, and therefore further discussion herein is not warranted.

The die 40 may have a die cutter or other extrusion-cutting device that is shaped to extrude the heated jacketing material 40 with a specific shape. Any type of die cutter shape may be used with the system 10. Most commonly, the die cutter may be configured to extrude the heated jacketing material 30 into a substantially flat, ribbon of jacketing material 32. In accordance with this disclosure, the ribbon of jacketing material 32 may be characterized as any portion of the extruded jacketing material 30 that is emitted from the die 40. The die 40 may provide the ribbon of jacketing material 32 with a substantially planar, elongated shape. This substantially uniform, flat, ribbon-like shape allows the ribbon of jacketing material 32 to be properly wrapped around the elongated object 20, such that it covers all intended surfaces of the elongated object 20. Other shapes of the ribbon of jacketing material 32 may also be used. This may include ribbon shapes with specific textures, such as raised ridges, raised edges, etc., all of which are considered within the scope of the present disclosure. For example, when the ribbon of jacketing material 32 is slightly overlapped, it may be desirable for it to be substantially flat, but have a transitioned thickness across the width of the ribbon of jacketing material 32.

When the ribbon of jacketing material 32 exits the die 40, it will still have a residual heated temperature from the pre-heated jacketing material 30. However, without further heating, the ribbon of jacketing material 32 is susceptible to hardening, deforming, or otherwise degrading in quality, which is likely to affect the quality of the jacketing on the elongated object 20. Accordingly, the system 10 includes a heating device 50 located proximate to the exit side 44 of the die 40. The heating device 50 provides a heated atmosphere to the ribbon of jacketing material 32, thereby preventing it from hardening into an unworkable state with the jacketing operation. In other words, the heating device 50 maintains the ribbon of jacketing material 32 in a heated state.

The heating device 50 may include many types of heating elements, heating environments, or heat-providing systems. For example, as is shown in FIG. 1, the heating device 50 may be a substantially enclosed, heated atmosphere that substantially surrounds at least a portion of an exterior surface of the elongated object 20. This substantially enclosed atmosphere may be heated with various heating sources, such as electrical, fossil fuels, etc., and may resemble the structure and design of an oven. In other words, the heating device 50 may include a laterally movable structure housing the heating device 50, where the heating device 50 and the laterally movable structure can be moved along the length of the elongated object 20. The heating device 50 may cover a cross sectional area of the elongated object 20 sufficiently to create a heated atmosphere proximate to that cross sectional area, but still allow the elongated object 20 to rotate freely and be moved independently of the heating device 50.

As one can see, it may be beneficial for the heating device 50 to be as enclosed as possible, to prevent heat dissipation and conserve energy, however, the heating device 50 may require various inlet and outlet ports to allow for the elongated object 20 to be inserted in, and exit from the enclosure. The inlet and outlet ports may be sized to closely fit the elongated object 20 with or without the ribbon of jacketing material 32 applied thereto. A sealing structure, constructed from rubber, plastic, or another material may be placed proximate to the inlet and outlet ports to prevent a substantial loss of heat from the inlet and outlet ports. Other configurations of heating devices 50 may also be used with the system 10. These may include heating devices 50 without enclosures, such as with heated-air that is directed towards the ribbon of jacketing material 32. Variations with the heating device 50 may be dependent on the type of jacketing material 30 used, and its properties.

A wrapping device 60 is positioned to rotate the elongated object 20 while the ribbon of jacketing material 32 is being applied. The wrapping device 60 may be a two-axis motion control device capable of rotating the elongated object 20 about an axis. As is shown in FIG. 1, the wrapping device 60 may have two supporting portions 62 connected together with a rotation member 64. The rotation member 64, which could include a plurality of rotation members 64, as is shown in FIG. 1, may attach to opposing ends of the elongated object 20. Preferably, the rotation members 64 are removably attached to symmetrically opposing ends of the elongated object 20 such that the elongated object 20 is rotated about a central axis, such as an axis parallel with the elongated axis of the elongated object 20. In this configuration, the elongated object 20 may be rotated in a stable manner (without wobbling) allowing for proper application of the ribbon of jacketing material 32. The rotation of the elongated object 20 may be powered by an electric motor, or any other device capable of causing a rotation. Other configurations and designs are available for the wrapping device 60, as one having ordinary skill in the art would understand, all of which are considered within the scope of the present disclosure.

The system 10 may be best described with respect to coordinates x, y, and z, as shown in FIG. 1: direction ‘x’ is parallel to the length of the elongated object 20 and the planar surface of the drawing sheet; direction ‘y’ is perpendicular to the length of the elongated object 20 and parallel to the planar surface of the drawing sheet; and direction ‘z’ is perpendicular to both the length of the elongated object 20 and the planar surface of the drawing sheet. In operation, the elongated object 20 is first rotated on the wrapping device 60 about an axis parallel to direction x. While the elongated object 20 is rotating, the heating device 50 is moved laterally about the length of the elongated object 20, i.e., along direction x. For example, with respect to FIG. 1, the heating device 50 may move from one of the supporting portions 62 of the wrapping device 60, to the other supporting portion 62. After being extruded through the die 40, the ribbon of jacketing material 32 is affixed or contacted with the elongated object 20. The rotation of the elongated object 20 may then wrap the ribbon of jacketing material 32 around the circumference of the elongated object 20, while the heating device 50 moves along direction x. This combination of movements—the rotation of the elongated object 20 about direction x, the lateral movement of the heating device 50 along direction x, and the extrusion of the ribbon of jacketing material 32, allows for the ribbon of jacketing material 32 to be properly placed on the exterior surface of the elongated object 20.

It is noted that the heating device 50 moves latterly about the elongated object 20 because the exit area of the ribbon of jacketing material 32 from the die 40 is within or proximate to the heating device 50. Thus, the ribbon of jacketing material 32 exiting the die 40 is moved along the elongated object 20, so the ribbon of jacking material 32 can be wrapped around the elongated object 20. As one can see, the rotation of the elongated object 20, the movement of the heating device 50 (and exit point of the ribbon of jacketing material 32 from the die 40), and the extrusion of the ribbon of jacketing material 32 from the die 40 may all need to occur in cooperation in order to successfully wrap the ribbon of jacketing material 32 about the elongated object 20. In other words, if one of the variable movements is too great or not great enough, the ribbon of jacketing material 32 may not be properly applied. For example, if the rotation of the elongated object 20 is too slow, then gaps between the wrapped ribbon of jacketing material 32 may occur. If the rotation of the elongated object 20 is too great, then substantially overlapping of the wrapped ribbon of jacketing material 32 may occur.

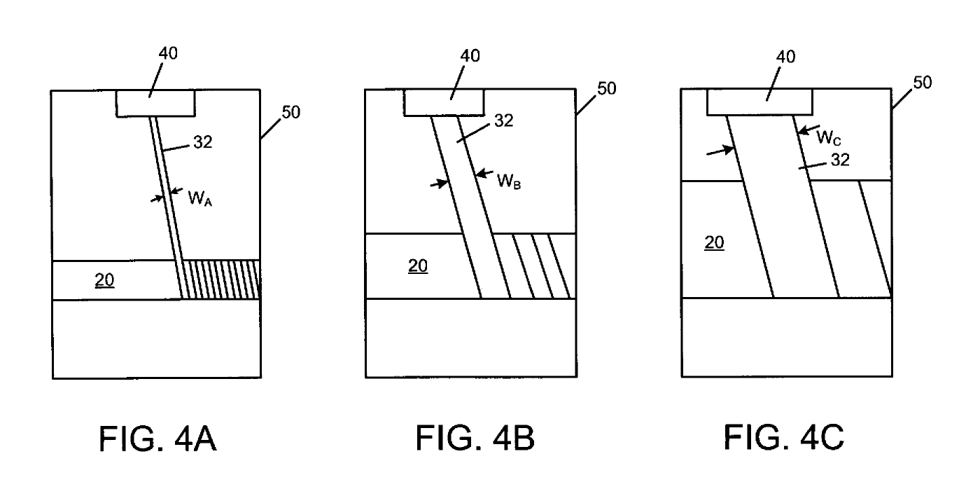

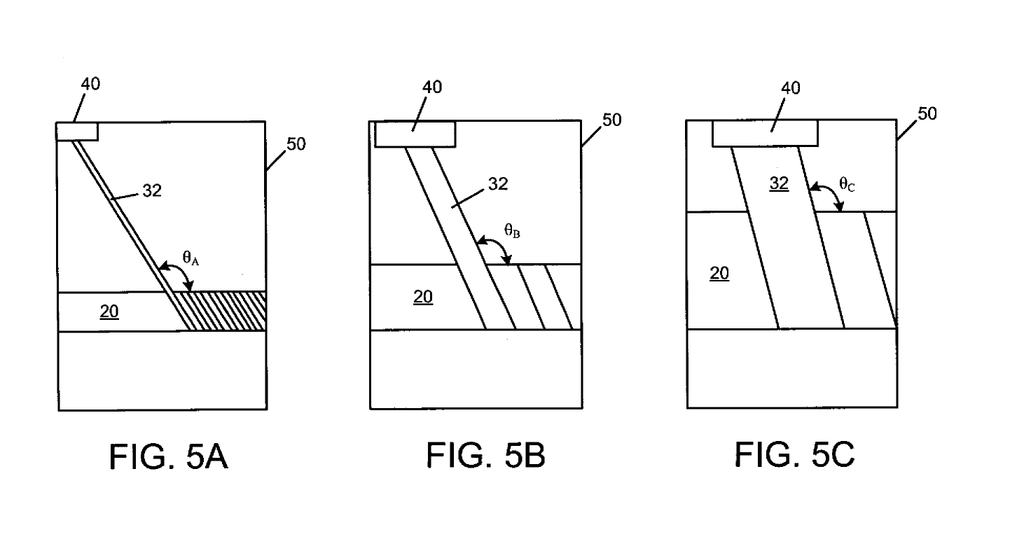

Thus, the various movements of the components of the system 10 may be relative. For example, the lateral movement of the heating device 50 may depend on the rotation of the wrapping device 60. If the wrapping device 60 moves slowly, then the heating device 50 will have a slow lateral movement to allow for proper covering of the elongated object 20 with the ribbon of jacketing material 32. The movement of the components of the system 10 may also vary depending on the size of either the elongated object 20, and/or the width of the ribbon of jacketing material 32. For example, if the width of the ribbon of jacketing material 32 is four inches, then the heating device 50 may move laterally at four inches per each rotation of the rotating device 60, assuming no overlap of the ribbon of jacketing material is needed. The interactions of the components of the system 10 to successfully jacket the elongated object 20 will be discussed further with respect to FIGS. 4A-4C and 5A-5C.

As is shown in FIG. 1, the wrapped ribbon of jacketing material 32 may be placed about the elongated object 20 is such as fashion as to create an jacketed surface 34 on the elongated object 20. This jacketed surface 34 is created from the substantially helical wrapping of the ribbon of jacketing material 32. As can also be seen in FIG. 1, the individual wrappings of the jacketed surface 34 may be distinguishable when the jacketed surface 34 is first applied, such as when the ribbon of jacketing material 32 is applied to the elongated object 20, but is still within the heating device 50. These individual wrappings may form one or more seams 36 located between the individual wrappings of the ribbon of jacketing material 32. The seams 36, which may be sealed edge seams, may be designed to fuse together with one another to form the jacketed surface 34. For example, as the ribbon of jacketing material 32 cures, from time, heat, or another catalyst, the seam 36 may be eliminated. For example, the seam 36 may be eliminated when the individual wrappings of the ribbon of jacketing material 32 are fused together. When the elongated object 20 with the jacketed surface 34 exits the heating device 50, the seams 36 may be completely eliminated, leaving a substantially uniform, unitary surface. This may be accomplished without the need for long water bath curing, or other curing techniques often required with conventional systems.

To aid in ensuring that the individual wrappings of the ribbon of jacketing material 32 form a unitary jacketed surface 34, a pressure application device 70 may be used to apply pressure to the ribbon of jacketing material 32 around the elongated object 20. The pressure application device 70 may include any device capable of applying a quantity of pressure to the ribbon of jacketing material 32, such as a roller biased with a spring. The positioning of the pressure application device 70 may vary, depending on the design of the system 10 and/or the need for pressure application. For example, the pressure application device 70 may be positioned to apply pressure to a seam 36 between two sections of the ribbon of jacketing material 32 applied to the elongated object 20. This may help ensure that the two sections properly fuse together, thereby eliminating the seams 36. Additionally, any number of pressure application devices 70 may be used to ensure that the jacketed surface 34 forms properly.

The system 10 may also include other components to aid in forming an extruded jacket over the elongated object 20. For example, the system 10 may include one or a plurality of temperature sensors 56 to monitor the temperature proximate to the heating device 50, and/or within the heating enclosure 52. The temperature sensor 56 may pair with an adjustable airflow mechanism 54, which may circulate air within the heating enclosure 52. Proper air circulation within the heating enclosure 52 may maintain a uniform temperature within the heating enclosure 52, which maintain the ribbon of jacketing material 32 at a uniform temperature. Maintaining the ribbon of jacketing material 32 at a substantially uniform temperature, from when it exits the die 40, to when it is fully in place around the elongated object 20, may ensure that the jacketed surface 34 is of sufficient quality, and won't be susceptible to unwanted imperfections.

Once the elongated object 20 with the jacketed surface 34 has cooled sufficiently, it may be used within a variety of industries and operations. Since many industries require various sizes, and types of elongated objects 20 and jacketed surfaces 34 covering those elongated objects 20, the system 10 may be fully adjustable and customizable to be successful in any industry or use. For example, the system 10 may jacket an elongated object 20 having a 1-inch diameter and/or an elongated object 20 having a 16-inch diameter with the same components, since the system 10 would not require a re-tooling or exchanging of parts, but only a slight adjustment of the system variables, i.e., the rate of rotation of the elongated object 20, the rate of lateral movement of the heating device 50, and the extrusion rate of the ribbon of jacketing material 32. This ability to quickly adjust the system 10 for use with a variety of elongated objects may eliminate the need for high-cost equipment conversion and set up tools.

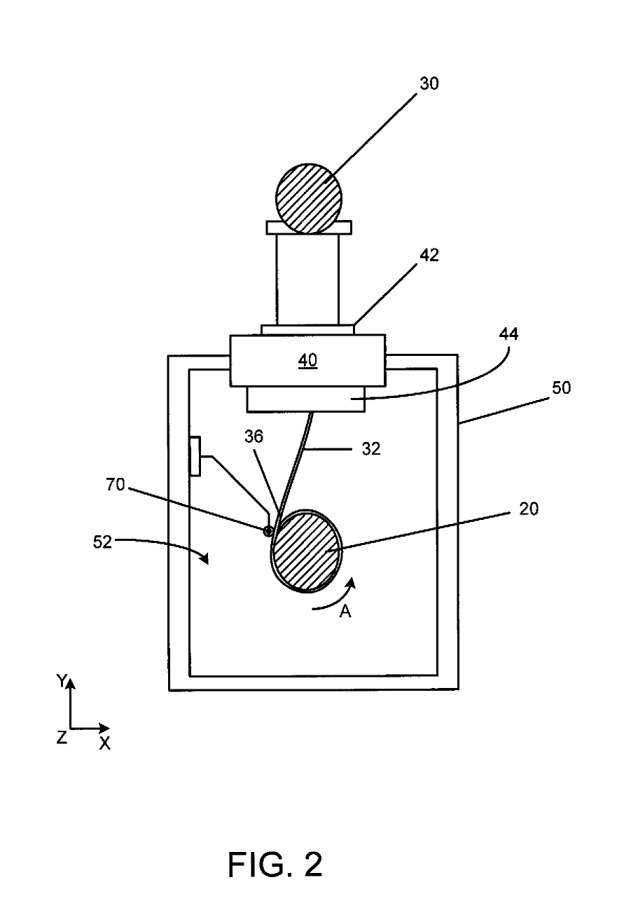

FIG. 2 is a side-view, cross-sectional illustration of a system 10 for forming an extruded jacket over an elongated object 20, in accordance with the first exemplary embodiment of the present disclosure. Specifically, FIG. 2 depicts the cross-sectional cut of the system 10 when viewed along the length of the elongated object 20, such that direction x is perpendicular to the planar drawing sheet. As can be seen, at least a portion of the elongated object 20 is within the heating device 50 and the heating enclosure 52. The portion of the elongated object 20 is wrapped with the ribbon of jacketing material 32, as the elongated object 20 is rotated. Arrow ‘A’ indicates the direction of rotation of the elongated object 20. In operation, the elongated object 20 would rotated in the direction of arrow A, while the ribbon of jacketing material 32 is extruded from the die 40. As this occurs, the heating device 50 and heating enclosure 52 move along direction x.

While the wrapping of the ribbon of jacketing material 32 is occurring, the pressure application device 70 is positioned to apply pressure to an area near where the ribbon of jacketing material 32 first contacts the elongated object 20. Although placement of the pressure application device 70 may vary, it may be most preferable for pressure to be applied very close to the initial formation of a seam 36 between sections of the ribbon of jacketing material 32, to ensure that the seam 36 is properly fused as the ribbon of jacketing material 32 cools. However, other placements of the pressure application device 70 may also be beneficial. For example, a pressure application device 70 may be located within an inlet or outlet port (not shown) of the heating enclosure 52, which may apply pressure to the fusing seam 36, but may also be used to interface the rotational movement of the elongated object 20 with the non-rotational movement of the heating enclosure 52.

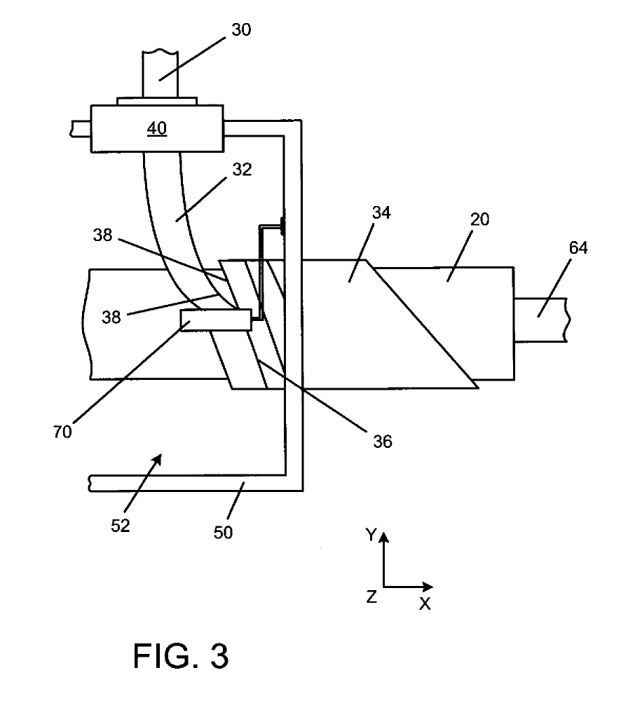

FIG. 3 is a partial cross-sectional illustration of a system 10 for forming an extruded jacket over an elongated object 20, in accordance with the first exemplary embodiment of the present disclosure. As can be seen in FIG. 3, the ribbon of jacketing material 32 is extruded from the die 40 and is wrapped about the elongated object 20. The pressure application device 70 may help ensure that a proper seam 36 occurs between the individual wrappings of the ribbon of jacketing material 32. For example, as the ribbon of jacketing material 32 is extruded, it may contact the elongated object 20, but may not be in the proper placement for creating a sufficient jacketed surface 34. In other words, the ribbon of jacketing material 32 may have gaps between the individual layers, or may be overlapped, or simply not properly aligned. The pressure application device 70 may assist with forming the seam 36 between the individual layers, but applying pressure on the ribbon of jacketing material 32 at the position on the elongated object 20 where it will form a correct seam with another section of the ribbon of jacketing material 32.

Formation of a seam 36 between individual layers of the ribbon of jacketing material 32 may vary. For example, as is depicted in FIG. 3, the seam 36 may be formed by the edges 38 of the ribbon of jacketing material 32 contacting each other, and subsequently fusing together. As is shown, the seams 36 within the heating enclosure 52 are shown fused together, such that they are eliminated once they exit the heating enclosure 52 and cool. Other seam 36 formations may be accomplished by contacting the edge 38 of the ribbon of jacketing material 32 with a non-edge portion of the ribbon of jacketing material 32. In other words, there may be some overlap between the individual layers of the ribbon of jacketing material 32 when the seam 36 is created. As one having ordinary skill in the art can see, other variations are also possible for creating the seam 36. In all variations, however, it is advantageous for the seam 36 to fuse together once the jacketed portion of the elongated object 20 has exited the heating enclosure 52 and sufficiently cooled, or otherwise cured.

FIGS. 4A-4C are cross-sectional illustrations of a system 10 for forming an extruded jacket over an elongated object 20, in accordance with the first exemplary embodiment of the present disclosure. When viewed together, FIGS. 4A-4C depict three possible variations on the width of the ribbon of jacketing material 32, which is indicated in FIGS. 4A-4C as ‘W_{A},’ ‘W_{B},’ and ‘W_{C},’ respectively. Accordingly, as the width of the ribbon of jacketing material 32 increases or decreases, the lateral movement of the heating device 50 must increase or decrease. For example, in FIG. 4A, the width of the ribbon of jacketing material 32, W_{A}, may equate to 10 rotations of the elongated object 20 to gain a certain distance along the length of the elongated object 20, perhaps two feet. Accordingly, as the width increases to W_{B} (FIG. 4B), perhaps only 5 rotations of the elongated object 20 are needed to gain a distance of two feet. When the width increases further to W_{C} (FIG. 4C), perhaps only 1 or 2 rotations are needed to gain two feet.

As can be seen, ribbons of the jacketing material 32 with varying widths may be used to jacket various elongated objects 20. In many cases, the larger diameter of the elongated object 20, the larger the width of the ribbon of jacketing material 32 may be. Likewise, the smaller the diameter of the elongated object 20, the smaller the width of the ribbon of jacketing material 32 may be. To convert the system 10 from one width of the ribbon of jacketing material 32 to another, a system operator may simply need to replace one die 40 with another. It is noted that the width of the ribbon of jacketing material 32 may depend on the material used for jacketing. Some materials may permit larger widths, whereas other materials may require smaller widths for proper jacketing. Other considerations for the width of the ribbon of jacketing material 32 may also be present, all of which are considered within the scope of the present disclosure.

FIGS. 5A-5C are cross-sectional illustrations of a system 10 for forming an extruded jacket over an elongated object 20, in accordance with the first exemplary embodiment of the present disclosure. When viewed together, FIGS. 5A-5C depict the varying wrapping angles that may be used with the system 10, identified as ‘θ_{A}’ for FIG. 5A, ‘θ_{B}’ for FIG. 5B, and ‘θ_{C}’ for FIG. 5C. The wrapping angle of the ribbon of jacketing material 32 may be characterized as the angle between the unwrapped quantity of the ribbon of jacketing material 32 and the elongated axis of the elongated object 20. With certain elongated objects 20, it may be advantageous to use a specific wrapping angle. For example, with elongated objects 20 having a smaller diameter, it may be beneficial to use a larger wrapping angle, such as θ_{A}, as shown in FIG. 5A. When the elongated object 20 has a larger diameter, it may be beneficial to use a smaller wrapping angle, such as θ_{C}, as is shown in FIG. 5C. As with the width of the ribbon of jacketing material 32, the specific wrapping angle may depend on many other factors, such as the speed of wrapping, the type of jacketing material used, and/or the desired jacketed surface.

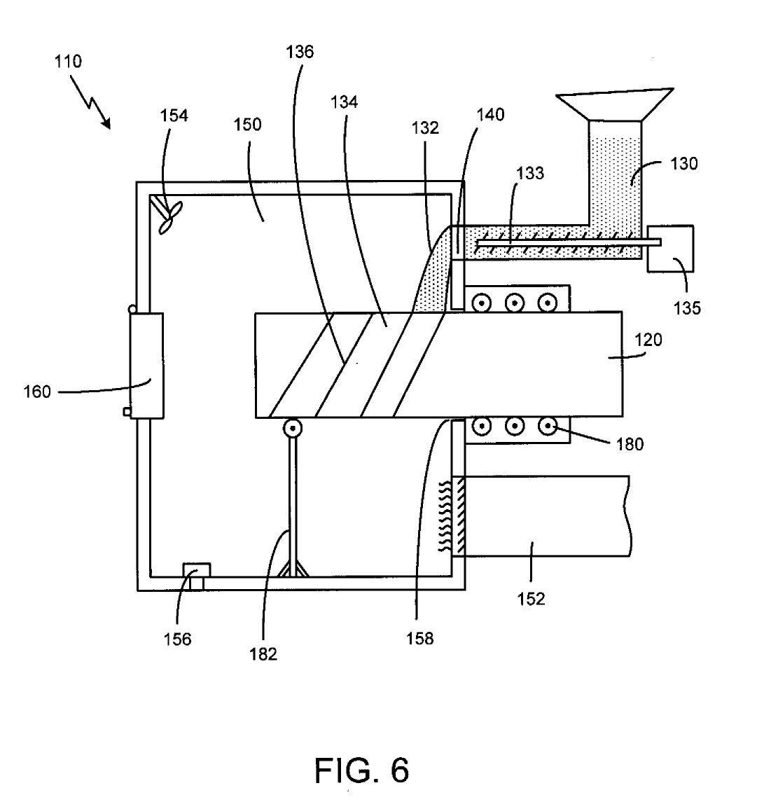

FIG. 6 is a cross-sectional illustration of a system 110 for forming an extruded jacket over an elongated object 120, in accordance with a second exemplary embodiment of the present disclosure. The system 110 may be substantially similar to the system 10 of the first exemplary embodiment, described with relation to FIGS. 1-5C. Any of the features, components, processes or configurations described with respect to the system 10 may be included with the system 110. The system 110 differs from the system 10 in that the system 110 forms an extruded jacket over an elongated object 120 with a different configuration from that which was described in FIGS. 1-3, and with varying component movements from what was described with respect to FIGS. 1-3.

The system 110 includes a quantity of heated jacketing material 130, which is positioned proximate to the elongated object 120. The quantity of heated jacketing material 130 may be formed from any material and may be made from solid pellets of jacketing material that are heated to form a malleable material having a substantially molten consistency capable of being extruded. The heated jacketing material 130 may include a variety of materials, including polymeric materials, polyvinyl materials, urethanes, 2-part polyethylene materials, other forms of vinyl, or any combination thereof. Other types of heated jacketing materials 130 may also be used, as one having ordinary skill in the art would recognize. The quantity of heated jacketing material 130 may be heated to a temperature that is dependent on the type of jacketing material used. The heated jacketing material 130 will be at a temperature that results in the heated jacketing material being a substantially molten consistency, soft enough to be malleable, but hard enough to take a given shape. This may include a substantially molten consistency that allows the quantity of heated jacketing material 130 to be extruded into a substantially flat sheet.

Once the quantity of heated jacketing material 130 is sufficiently heated, it is transported to at least one die 140. The quantity of heated jacketing material 130 may be transported via any method or device, such as a rotatable corkscrew shaft 133 powered by a motor 135, as illustrated in FIG. 6. Any number of dies 140, or crosshead dies, may be used with the system 110. The die(s) 140 has an entry side located proximate to the quantity of heated jacketing material 130 and an exit side located distal from the quantity of heated jacketing material 130. The quantity of heated jacketing material 130 may enter the entry side of the die 140, be extruded through the die 140 and take the shape of the die 140, and then exit the die 140 via the exit side of the die 140 with the extruded shape. This extruded quantity of heated jacketing material 130 may have any shape, as would be determined by the shape of the die 140, but will commonly have a flat or planar shape thereby resulting in a flat sheet or ribbon of jacketing material 132. The flat or planar shape may be substantially uniform or may vary by design. For example, the ribbon of jacketing material 132 may have a transitioned thickness across its width.

Directly abutting the exit side of the die 140 is a heating device 150, which may be a substantially enclosed, heated atmosphere, and referred to as such. The heated atmosphere 150 may be any type of oven or heated enclosure, heated by any type of heating device and including any type of additional heating components, such as circulating fans 154. The heated atmosphere 150 may have an adjustable air flow provided at a predetermined flow rate to maintain a uniform temperature within the heated atmosphere 150. The heated atmosphere 150 may have any temperature that is sufficient to keep the flat sheet of jacketing material 132 at a usable temperature and molten state for jacketing the elongated object 120. The ribbon of jacketing material 132 exits the die 140 into the heated atmosphere 150, which retains the ribbon of jacketing material 132 at a usable temperature. The usable temperature is any temperature wherein the ribbon of jacketing material 132 can be wrapped around the exterior of the elongated object 120.

As is illustrated in FIG. 6, the heated atmosphere 150 may include a hot air inlet 152 and a circulating fan 154 to move the heated air throughout the heated atmosphere 150. A temperature sensor 156 may also be included to monitor the temperature within the heated atmosphere 150. The heated atmosphere 150 may have at least one opening, but may preferably have an entry opening 158 facilitating entry of the elongated object 120, and an exit opening 160 allowing the elongated object 120 to exit the heated atmosphere 150 with a jacketing surface 134. As one having ordinary skill in the art can see, a variety of designs, configurations and additional components may be included with the system 110, all of which are considered within the scope of the present disclosure.

Once the ribbon of jacketing material 132 is within the heated atmosphere 150, it is positioned proximate to the elongated object 120. The elongated object 120 may be rotated about an elongate axis within the heated atmosphere 150 with a series of movement mechanisms 180, such as control-activated rollers. The elongated object 120 may be moved laterally along an axis parallel to the elongated length of the elongated object 120 within the heated atmosphere 150. Similarly, elongated object 120 may remain stationary and the ribbon of jacketing material 132 may be moved laterally along an axis of the elongated object 120. As the elongated object 120 is rotated, the ribbon of jacketing material 132 contacts an exterior surface of the elongated object 120. The continual rotation and lateral movement between the elongated object 120 and the ribbon of jacketing material 132, in combination with the continual contact of the ribbon of jacketing material 132 results in a jacketing surface 134 being formed on the elongated object 120.

A winding apparatus (not shown) may be used to wrap the ribbon of jacketing material 132, similar to what was described with respect to the first exemplary embodiments. The jacketing surface 134 is wrapped around the exterior surface of the elongated object 120 and substantially surrounds the elongated object 120. The jacketing surface 134 may be wrapped in a helical fashion to form a uniform, smooth protective covering for the elongated object 120. A support structure 182 may support the elongated object 120 with the jacketing surface 134 as it moves through the heated atmosphere 50. The support surface may also act as a pressure applicator to the jacketing surface 134, which may help seal any seams between individual pieces of the ribbon of jacketing material 132.

The jacketing surface 134 on the elongated object 120 may fully surround the elongated object 120 and may be virtually seamless, as the jacketing surface 134 fuses together to surround the elongated object 120 without seams. However, the surrounding jacketing surface 134 may also have a seam 136, or sealed edge seam between various portions of the jacketing surface 134, especially when it is still within the heated atmosphere 150. In accordance with this disclosure, any covering of the elongated object 120 with the jacketing surface 134 may or may not include a seam 136 within the jacketing surface 134. Once the jacketing surface 134 is wrapped around the exterior surface of the elongated object 120, the heated atmosphere 150 may keep the elongated object 120 with jacketing surface 134 at a heated temperature for any period of time. The elongated object 120 with jacketing surface 134 may then be cooled within the heated atmosphere 150 or outside of the heated atmosphere 150.

Once the elongated object 120 with jacketing surface 134 has cooled sufficiently, it may be used within a variety of industries and operations. The system 110 may be fully adjustable and customizable to be successful in any industry or use. For example, the angle of wrapping, the width of the ribbon of jacketing material 134, the size or design of the die 140, the rate of lateral movement of the elongated object 120, or any other feature of the jacketing apparatus may be adjusted as needed. The system 110 may be compatible with, and used successfully with any size of elongated object 120 without needing to change the components of the system 110. For example, the system 110 may jacket an elongated object 120 having a 1-inch diameter and an elongated object 120 having a 16-inch diameter with the same components. This may eliminate the need for high-cost equipment conversion and set up tools.

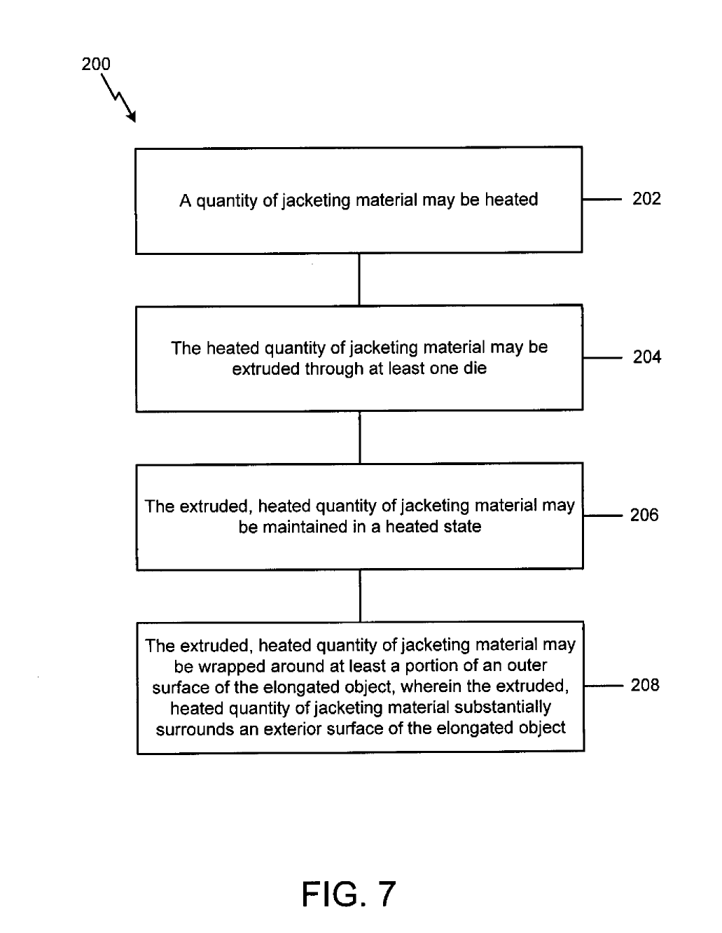

FIG. 7 is a flowchart 200 illustrating a method for forming an extruded jacket over an elongated object 20, accordance with the first exemplary embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown at block 202, a quantity of jacketing material 30 may be heated. The heated quantity of jacketing material 30 may be extruded through at least one die 40 (block 204). The extruded, heated quantity of jacketing material 32 may be maintained in a heated state (block 206). The extruded, heated quantity of jacketing material 32 may be wrapped around at least a portion of an outer surface of the elongated object 20, wherein the extruded, heated quantity of jacketing material 32 substantially surrounds an exterior surface of the elongated object 20 (block 208).

May additional steps or processes may be included with the method, as well as many variations to the presently described method steps. For example, the extruded, heated quantity of jacketing material 32 may be maintained in a heated state by placing it in a substantially enclosed heated atmosphere proximate to an exit side 42 of the at least one die 40. Thus, the quantity of jacketing material 30 exits the at least one die 40 into the heated, enclosed atmosphere. To wrap the quantity of jacketing material 32, referred to as the ribbon of jacketing material 32, the elongated object 20 may be rotated within the substantially enclosed, heated atmosphere, as is described with respect to FIG. 1. Similarly, the substantially enclosed, heated atmosphere may be moved laterally along the length of the elongated object 20 to ensure that the ribbon of jacketing material 32 is properly applied to the elongated object 20.

Additionally, steps may also be used to ensure that the jacket surface 34 applied to the elongated object 20 is suitable to withstand the elongated object's 20 intended use. For example, the heated quantity of jacketing material 30 and/or the ribbon of jacketing material 32 may need to be maintained at a substantially uniform temperate during the jacketing process. Additionally, once the ribbon of jacketing material 32 is applied, pressure may need to be applied to a seam 36 between at least two sections of ribbon of jacketing material 32 around the elongated object 20. To cure the ribbon of jacketing material 32 into the jacketed surface 34, the sections of wrapped ribbons of jacketing material 32 may need to be cooled, thereby eliminating the seam 36.

Depending on various aspects of the jacketing process, the method may require determining at least one of an angle of the wrapping the ribbon of jacketing material 32 around at least a portion of an outer surface of the elongated object 20, a width of the ribbon of jacketing material 32, and a lateral movement of the heating device 50 about a length of the elongated object 20 as a function of a size of the elongated object 20. The size of the elongated object 20 may include a diameter of the elongated object 20 and/or a length of the elongated object 20. Any additional steps or processes not explicitly recited herein may also be used with the method, all of which are considered within the scope of the present disclosure.

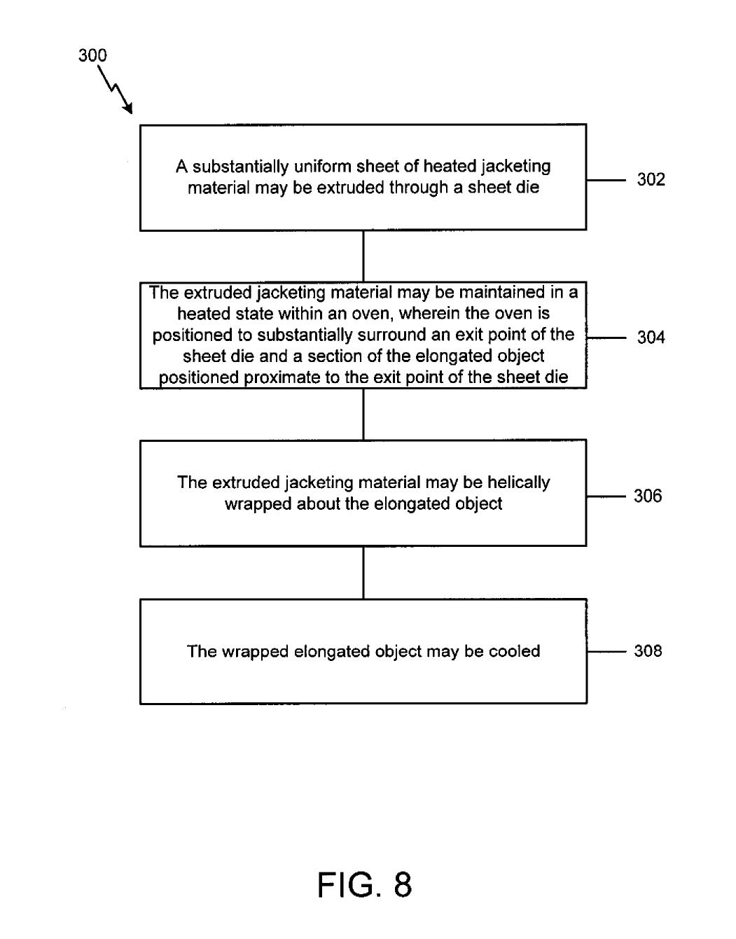

FIG. 8 is a flowchart 300 illustrating a method for forming an extruded jacket over an elongated object, accordance with a third exemplary embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown at block 302, a substantially uniform sheet of heated jacketing material may be extruded through a sheet die. The extruded jacketing material may be maintained in a heated state within an oven, wherein the oven is positioned to substantially surround an exit point of the sheet die and a section of the elongated object positioned proximate to the exit point of the sheet die (block 304). The extruded jacketing material may be helically wrapped about the elongated object (block 306). The wrapped elongated object may be cooled (block 308). Additional steps may include rotating the elongated object about an elongated axis of the elongated object and laterally moving the sheet die and oven along the elongated axis of the elongated object.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A system for forming an extruded jacket over an elongated object, the system comprising:
a quantity of heated jacketing material;
at least one die having an entry side and an exit side, the entry side proximate to the quantity of heated jacketing material, wherein the quantity of heated jacketing material is extruded through the at least one die;
a heating device located proximate to the exit side of the at least one die, the heating device positioned to maintain the extruded quantity of heated jacketing material in a heated state; and
a wrapping device positioned to rotate the elongated object, wherein the extruded quantity of heated jacketing material is wrapped around at least a portion of the elongated object.

2. The system for forming an extruded jacket over an elongated object of claim 1, wherein the at least one die further comprises a sheet die, wherein the quantity of heated jacketing material is a substantially uniform, flat sheet.

3. The system for forming an extruded jacket over an elongated object of claim 1, wherein the heating device further comprises a substantially enclosed, heated atmosphere, substantially surrounding at least a portion of an exterior surface of the elongated object.

4. The system for forming an extruded jacket over an elongated object of claim 1, further comprising a laterally movable structure housing the heating device, wherein the laterally movable structure is movable along the length of the elongated object.

5. The system for forming an extruded jacket over an elongated object of claim 1, further comprising a seam formed between at least two sections of wrapped quantity of heated jacketing material around the elongated object, wherein the seam is eliminated as the wrapped quantity of heated jacketing material cools.

6. The system for forming an extruded jacket over an elongated object of claim 1, further comprising a pressure application device positioned to apply pressure to the wrapped quantity of heated jacketing material around the elongated object.

7. The system for forming an extruded jacket of an elongated object of claim 6, wherein the pressure application device is positioned to apply pressure to a seam between at least two sections of wrapped quantity of heated jacketing material around the elongated object.

8. The system for forming an extruded jacket of an elongated object of claim 1, further comprising at least one of a temperature sensor and an adjustable air flow rate device positioned proximate to the heating device.

9. A method for forming an extruded jacket over an elongated object, the method comprising the steps of:
heating a quantity of jacketing material;
extruding the heated quantity of jacketing material through at least one die;
maintaining the extruded, heated quantity of jacketing material in a heated state; and
wrapping the extruded, heated quantity of jacketing material around at least a portion of an outer surface of the elongated object, wherein the extruded, heated quantity of jacketing material substantially surrounds an exterior surface of the elongated object.

10. The method for forming an extruded jacket over an elongated object of claim 9, wherein the step of maintaining the extruded, heated quantity of jacketing material in a heated state further comprises heating a substantially enclosed heated atmosphere proximate to an exit side of the at least one die, wherein the quantity of jacketing material exits the at least one die into the heated, enclosed atmosphere

11. The method for forming an extruded jacket over an elongated object of claim 10, further comprising the step of rotating the elongated object within the substantially enclosed, heated atmosphere.

12. The method for forming an extruded jacket over an elongated object of claim 10, further comprising the step of laterally moving the substantially enclosed heated atmosphere along a length of the elongated object.

13. The method for forming an extruded jacket over an elongated object of claim 9, further comprising the step of laterally moving the heating device along a length of the elongated object.

14. The method for forming an extruded jacket over an elongated object of claim 9, further comprising the step of maintaining a substantially uniform temperature within the heated quantity of jacketing material.

15. The method for forming an extruded jacket over an elongated object of claim 9, further comprising the steps of:
applying pressure to a seam between at least two sections of wrapped quantity of heated jacketing material around the elongated object; and
cooling the at least two sections of wrapped quantity of heated jacketing material to eliminate the seam.

16. The method for forming an extruded jacket over an elongated object of claim 9, further comprising the step of determining at least one of an angle of the wrapping the extruded, heated quantity of jacketing material around at least a portion of an outer surface of the elongated object, a width of the extruded quantity of jacketing material, and a lateral movement of the heating device about a length of the elongated object as a function of a size of the elongated object.

17. The method for forming an extruded jacket over an elongated object of claim 15, wherein the size of the elongated object further comprises at least one of a diameter of the elongated object and a length of the elongated object.

18. A method for forming an extruded jacket over an elongated object, the method comprising the steps of:
extruding a substantially uniform sheet of heated jacketing material through a sheet die;
maintaining the extruded jacketing material in a heated state within an oven, wherein the oven is positioned to substantially surround an exit point of the sheet die and a section of the elongated object positioned proximate to the exit point of the sheet die;
helically wrapping the extruded jacketing material about the elongated object; and
cooling the wrapped elongated object.

19. The method for forming an extruded jacket over an elongated object of claim 18, wherein the elongated object is a substantially cylindrical object.

20. The method for forming an extruded jacket over an elongated object of claim 18, wherein the step of helically wrapping the extruded jacketing material about the elongated object further comprises:
rotating the elongated object about an elongated axis of the elongated object; and
laterally moving the sheet die and oven along the elongated axis of the elongated object.
